(19) United States
(12) Patent Application Publication
(10) Pub. No.: US 2010/0158410 A1
(43) Pub. Date: Jun. 24, 2010

(54) IMAGE PROCESSING APPARATUS, IMAGE PROCESSING METHOD AND COMPUTER-READABLE STORAGE MEDIUM

(75) Inventor: Minoru Kusakabe, Yokohama-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/640,217

(22) Filed: Dec. 17, 2009

(30) Foreign Application Priority Data
Dec. 19, 2008 (JP) 2008-323643

(51) Int. Cl. G06K 9/36; G06K 9/32; G06T 1/00; G06K 15/02

(52) U.S. Cl. 382/284; 382/298; 382/299; 345/428; 358/1.2

(57) ABSTRACT

An image processing apparatus creates an image file. The image processing apparatus generates a reduced image by reducing an input image and generates a plurality of divided images by dividing the input image. Then, an image file is created containing the reduced image and the plurality of divided images and containing, in one index area, position information indicating the position to which each of the plurality of divided images corresponds in the input image. As a result, it is possible to access a high-resolution image at a high speed and to create an image file that can be easily handled by a user.

### FIELD OF THE INVENTION

The present invention relates to an image processing apparatus and an image processing method that create an image file having a plurality of images.

### BACKGROUND OF THE INVENTION

In recent years, the resolution of image input devices, such as digital cameras and scanners, has become higher, and the number of pixels in a generated image has increased. Additionally, image output devices that output an image generated by the above-mentioned image input devices have become widely popular. Examples thereof include mobile phones that display an image on an installed display panel and printers that print an image on printing paper. However, the data processing performance of image output devices has not caught up with the higher resolution of image input devices in recent years. As a consequence, it sometimes takes considerable time to output an image having a large number of pixels. For example, in a case where an image is to be displayed in such a manner that the reduction/expansion thereof is switched, an expansion process and a reduction process need to be repeated on a block to be displayed within a high-resolution image each time reduction/expansion of the image is performed. Accordingly, methods for displaying an image having a large number of pixels at a high speed have been proposed.

As such a method, in the method disclosed in Japanese Patent Laid-Open No. 11-88866, a plurality of files having a plurality of images each having a different resolution, which are generated from the original image, are prestored in a server. Then, when an image is to be expanded and displayed in a client, an area necessary for display within an image file having a resolution close to the display magnification ratio requested by the client is extracted and is provided from the server to the client. As a result, it is not necessary to perform an expansion process and a reduction process on a high-resolution image file each time the display magnification ratio is changed, thereby making it possible to speed up image output.

Furthermore, in Japanese Patent Laid-Open No. 11-312173, a method is disclosed in which a plurality of image files of different resolutions are stored in a predetermined storage device, such as the server disclosed in Japanese Patent Laid-Open No. 11-88866. In that document, it is described that an image of each resolution is divided into rectangular image blocks, each of the plurality of divided image blocks is compressed and encrypted, and furthermore, these image blocks are combined so as to be formed as a single file. As a result, even if an image is divided into blocks, the number of files can be made to fall within the number of resolutions.

However, in this method, although a plurality of image blocks can be managed as a single file in the apparatus that manages files, a plurality of files need to be managed in the long run, and this may become complex. For example, it is considered that the above-mentioned plurality of files are stored on an external storage medium, such as a memory card, the storage medium is loaded into another device, and a file is copied and then used. In this case, even in a case where a user wants to copy an image file regarding one object, there is a problem in that files of all the resolutions regarding the object need to be copied. Furthermore, in a case where an image regarding a plurality of objects has been put in one folder, a plurality of image files exist for each object. As a consequence, there is a possibility that the user cannot identify the appropriate file to be selected.

### SUMMARY OF THE INVENTION

The present invention provides an image processing apparatus capable of accessing a high-resolution image at a high speed and capable of generating an image file that can be easily accessed.

The present invention provides an image processing apparatus that creates an image file, including: an input unit configured to input an image; a generation unit configured to generate a reduced image by reducing the input image and configured to generate a plurality of divided images by dividing the input image; and a creation unit configured to create an image file containing the reduced image and the plurality of divided images and containing, in one index area, a plurality of items of position information indicating a position to which each of the plurality of divided images corresponds in the input image.

Further features of the present invention will become apparent from the following description of exemplary embodiments with reference to the attached drawings.

### BRIEF DESCRIPTION OF THE DRAWINGS

FIG. 1 is an exterior view showing the exterior of an MFP 100.

FIG. 2 is a block diagram showing the configuration of the MFP 100.

FIGS. 3A, 3B, and 3C are illustrations of a multi-image format in the present embodiment.

FIGS. 4A, 4B, and 4C are illustrations of an index IFD (Image File Directory) of a multi-image format in the present embodiment.

FIG. 5 is an illustration of an individual image information IFD of a multi-image format in the present embodiment.

FIG. 6 shows a software structure that creates a multi-image format file according to a first embodiment of the present invention.

FIG. 7 shows a flow in which processing is performed on the basis of the software structure shown in FIG. 6 so as to generate an output image.

FIG. 8 illustrates a method for creating a file of a multi-image format according to the first embodiment of the present invention.

FIG. 9 shows a software structure that outputs a multi-image format file according to the first embodiment of the present invention.

FIG. 10 shows a flow in which processing is performed on the basis of the software structure shown in FIG. 9 so as to generate an output image.

FIGS. 11A, 11B, and 11C show extraction of an image when an image file of a multi-image format according to the first embodiment of the present invention is to be output.

FIG. 12 shows a selection of an image when an image file of a multi-image format according to the first embodiment of the present invention is to be output.

FIG. 13 shows a software structure that creates a multi-image format file according to a second embodiment of the present invention.

FIG. 14 shows a flow in which processing is performed on the basis of the software structure shown in FIG. 13 so as to create a multi-image format file.

FIG. 15 illustrates generation of a file of a multi-image format according to the second embodiment of the present invention.

FIG. 16 shows a software structure that creates a multi-image format file according to a third embodiment of the present invention.

FIG. 17 shows a flow in which processing is performed on the basis of the software structure shown in FIG. 16 so as to create a multi-image format file.

FIG. 18 illustrates generation of a multi-image format file according to the third embodiment of the present invention.

### DESCRIPTION OF THE EMBODIMENTS

### First Embodiment

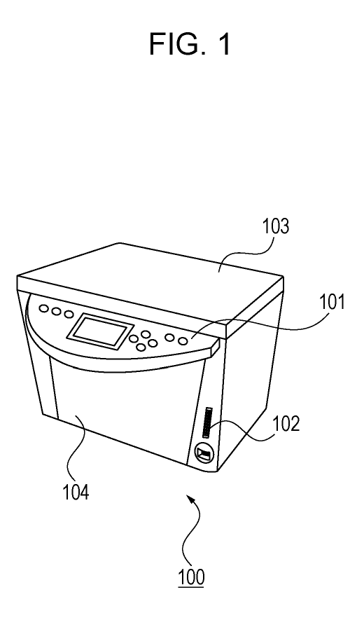

FIG. 1 is an exterior view showing the exterior of an MFP 100 in the embodiment. An operation unit 101 is operated by a user, so that instructions are supplied to the MFP 100. Furthermore, a card interface 102 serving as a loading unit is provided, so that an external storage medium, such as a memory card, can be loaded thereinto. Furthermore, a reading unit 103 is provided. When the user opens a document holder cover, places a document on the document holder, and operates the operation unit 101, the document can be read. A printing unit 104 is able to print image data read from an external device or from a card loaded into the card interface, and image data read by the reading unit 103. As shown in FIG. 1, usually, the MFP 100 is disposed in a state in which the document holder cover of the reading unit 103 and the paper-eject tray of the printing unit 104 are closed. When reading, copying, or printing from the card is to be performed, the document holder cover and the paper-eject tray are opened as appropriate.

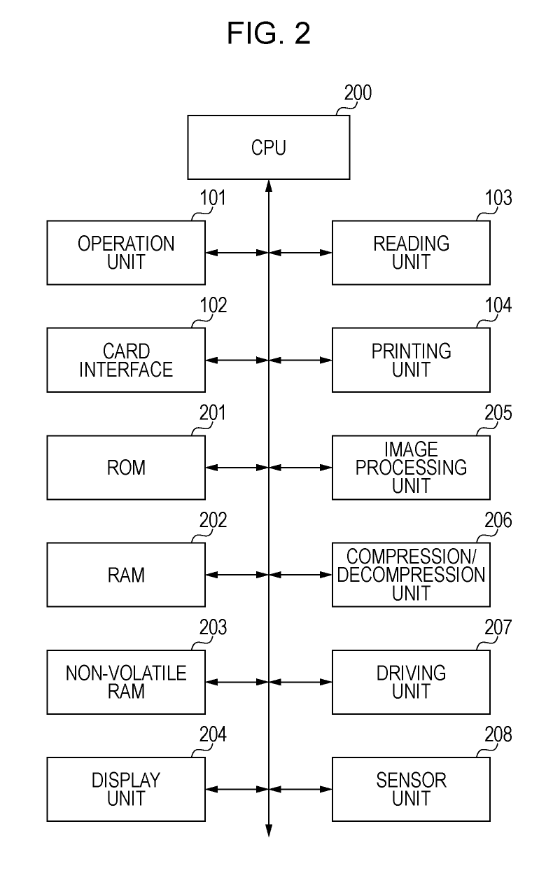

FIG. 2 is a block diagram showing the configuration of the MFP 100. The operation unit 101, the card interface 102, the reading unit 103, and the printing unit 104 in FIG. 2 are identical to those described with reference to FIG. 1. A CPU 200 controls various functions provided in the MFP 100. A ROM 201 has a control command program for the MFP 100 stored therein. A RAM 202 is a memory serving as a storage unit for temporal storage. The CPU 200 executes a program of image processing, which is stored in the ROM 201, by using the RAM 202 as a work memory. Furthermore, a non-volatile RAM 203 is a battery backed-up SRAM or the like, and stores data unique to the MFP 100, and the like.

The reading unit 103 includes reading sensors, such as CCDs. The reading sensors scan and read the document image, and output analog luminance data of red (R), green (G), and blue (B). For the reading sensors, in addition to CCDs, contact image sensors (CIS) may be used. An external storage medium, such as a memory card, is loaded into the card interface 102. An image read by the reading unit 103 under the control of the CPU 200 is stored on the loaded external storage medium. Furthermore, for example, in a case where an external storage medium on which images captured using a digital still camera have been stored is loaded, a function of reading these images under the control of the CPU 200 is provided. Image data stored via the card interface 102, and image data read via the interface can be subjected to desired image processing in an image processing unit 205 (to be described later).

In a compression/decompression unit 206, a compression/decompression process for an image read by the reading unit 103 and an image to be output by the printing unit 104 is performed. Examples thereof include a process for generating and decompressing a compressed image using JPEG or the like. In the image processing unit 205, a process for inputting an image read by the reading unit 103 and an image decompressed by the compression/decompression unit 206 is performed. Furthermore, a process for outputting an image in which the image read via the card interface 102 is decompressed by the compression/decompression unit 206 is also performed. In input image processing and output image processing, conversion between a color space (for example, YCbCr) used for a digital camera or the like and a standard RGB color space (for example, NTSC-RGB or sRGB) is performed. Functions of a process for converting the resolution of image data, a process for generating and analyzing header information contained in an image file including image data, an image analysis process and an image correction process, a process for generating and correcting thumbnail images, and the like are also provided. The image data obtained by these image processings is stored in the RAM 202, and in a case where the image data is to be stored in a memory card via the card interface 102, a storage process is performed when the image data reaches a necessary predetermined amount. Also, in a case where the image data is to be printed by the printing unit 104, when the image data reaches a necessary predetermined amount, a printing operation is performed by the printing unit 104.

The operation unit 101 has a direct photograph printing start key for selecting image data stored on the storage medium and starting printing. Furthermore, the operation unit 101 has a scan start key used to start reading a monochrome image or a color image, and a monochrome copy start key and a color copy start key used for copying. Furthermore, the operation unit 101 also includes a mode key for specifying a mode for the resolution, image quality, and the like of copying and scanning, a stop key for stopping the operation of copying and the like, a ten-key pad for inputting the number of copies and a registration key, cursor keys for specifying a unit for selecting an image file to be printed, and the like. When one of these keys is pressed, an instruction is input to the CPU 200. That is, the CPU 200 detects the pressed state of the key and controls each unit in response to the pressed state. A display unit 204 displays the content in response to the key pressed state of the operation unit 101. The display unit 204 also displays the content of the processing that is being currently performed by the MFP 100, and the like.

The printing unit 104 is constituted by an ink jet head of an ink jet method, general-purpose ICs, and the like. The printing unit 104 reads printing data stored in the RAM 202, and prints and outputs it as a hard copy under the control of the CPU 200. A driving unit 207 is constituted by a stepping motor for driving paper-feed/ejection rollers, gears for transferring the driving force of the stepping motor, a driver circuit for controlling the stepping motor, and the like in the operation of each of the reading unit 103 and the printing unit 104. A sensor unit 208 is constituted by a printing paper width sensor, a printing paper presence/absence sensor, a document width sensor, a document presence/absence sensor, a printing sheet detection sensor, and the like. The CPU 200 detects the statuses of the document and the printing paper on the basis of the information obtained from these sensors.

Next, file generation according to the present invention will be described. In the present invention, the original one image (hereinafter referred to as an original image) is reduced or divided so as to generate a plurality of images, so that an image file of a multi-image format in which the plurality of images are contained is created.

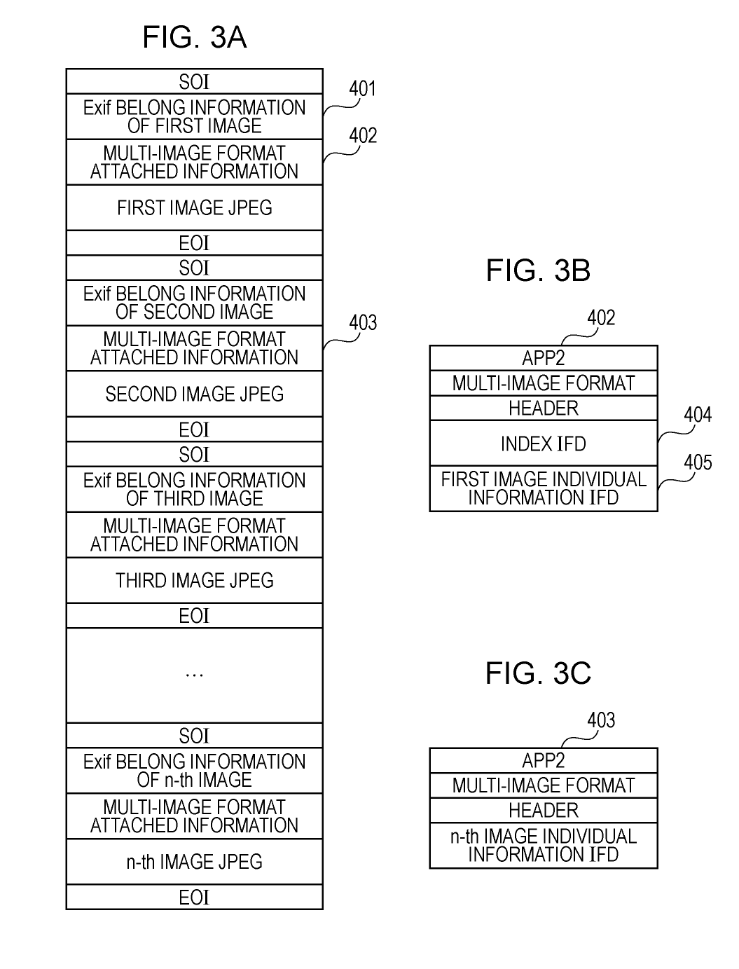

FIGS. 3A, 3B, and 3C are illustrations of a multi-image format in the present embodiment. FIG. 3A shows a multi-image format, in which a plurality of JPEG images that begin with an SOI (Start Of Image) marker and that end with an EOI (End Of Image) marker are combined. Following the SOI marker at the file beginning, Exif belong information 401 of a first image, multi-image format attached information 402 of the first image, and the first image compressed with JPEG exist. After the first image compressed with JPEG, an EOI marker exists.

Furthermore, following the EOI marker of the first image, an SOI marker of a second image exists. Following that, the Exif belong information of the second image, the multi-image format attached information 403 of the second image, and the second image compressed with JPEG exist. Another information may exist between the EOI marker of the first image and the SOI marker of the second image.

Following the EOI marker of the second image, an SOI marker of the third image exists. Following that, the Exif belong information of the third image, the multi-image format attached information 403, and the third image compressed with JPEG exist. Another information may exist between the EOI marker of the second image and the SOI marker of the third image. The second image and the third image continue in a similar manner up to the n-th image.

FIGS. 3B and 3C show multi-image format attached information of the first image and an image other than the first image, respectively. The multi-image format attached information 403 of the image other than the first image, shown in FIG. 3C, contains an APP2 marker and an identifier indicating being a multi-image format. This identifier is shown as a multi-image format in FIG. 3C, and furthermore a header and an individual image information IFD are provided. The multi-image format attached information of the n-th image contains information unique to the n-th image. For example, the information indicates the sequential position of the image in the file.

On the other hand, the multi-image format attached information of the image of the first image shown in FIG. 3B contains, in addition to the multi-image format attached information of the image other than first image, an index IFD (Image File Directory) 404. The index IFD 404 indicates the entire structure from the first image to the n-th image.

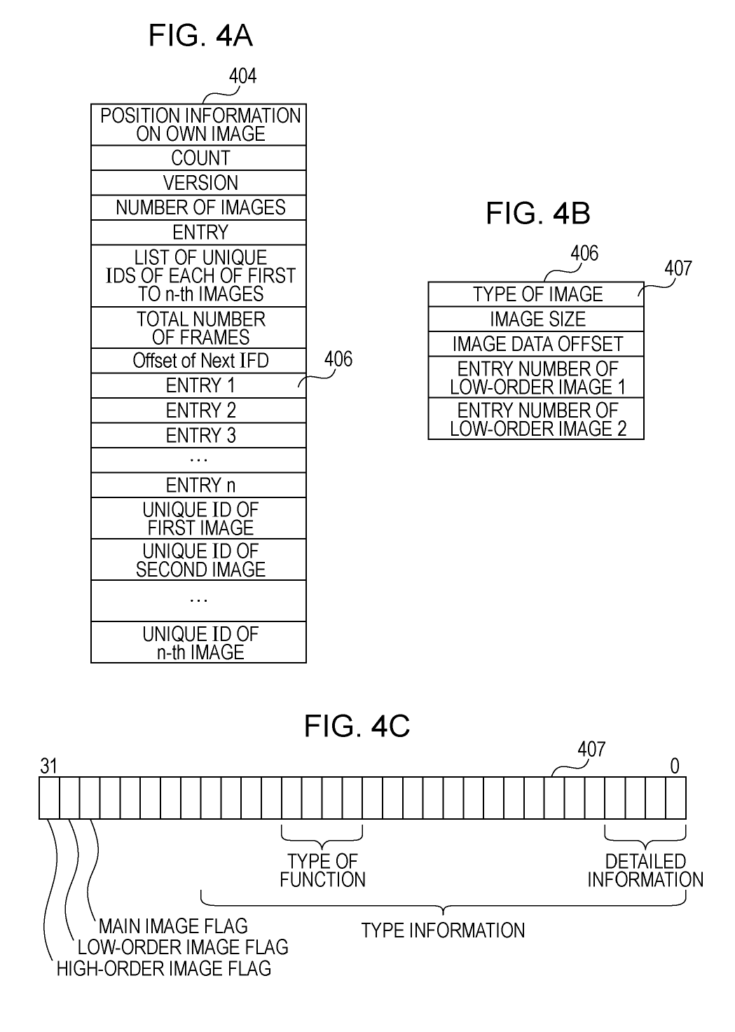

FIGS. 4A, 4B, and 4C are illustrations of an index IFD of a multi-image format in the present embodiment. FIG. 4A shows an internal structure of an index IFD. This corresponds to the index IFD 404 in FIG. 3B, and only the multi-image format attached information of the first image has an index IFD.

The index IFD 404 contains the version of a multi-image format, the number of images contained in the file, an offset from the entry of a first image, a list of unique IDs from the first image to the n-th image, the total number of frames, and an offset value to the next IFD. Furthermore, as the values of the IFDs, the entry 406 of each of the first image to the n-th image and the unique IDs from the first image to the n-th image are stored. The entry 406 will be described later. As described above, the information contained inside the multi-image format attached information of the first image differs from the multi-image format attached information of the second and subsequent images.

FIG. 4B shows the structure of the entry 406 of each of the first image to the n-th image. The entry 406 of each of the first image to the n-th image has stored therein a type 407 of the image, an image data offset that is an offset to the JPEG data of each image, an entry number of a low-order image 1, and an entry number of a low-order image 2.

The low-order image refers to an image having a subordinate relationship to the target image. The entry number of the low-order image 1 and the entry number of the low-order image 2 indicate the sequential position of the images that are low-order images in the file. In that case, the target image becomes a high-order image with respect to the low-order image.

FIG. 4C shows the internal structure of the type 407 of the image. Here, in addition to the above-mentioned high-order image and low-order image, a main image is defined. The reason for this is that the case in which all the images are not in parallel relation to one another in the multi-image format file is more effective. For example, although the user can select an image to be displayed from among the plurality of images contained in the file when a monitor display is to be performed, the image displayed first is important for the user. For example, in the case of a file that is captured and stored in such a manner that a bracket image capturing function is used so as to change white balance in steps (+ and −), in order for the user to select an image, it is considered to be preferable that, first, an image at a position at which white balance is 0, which is a criterion, be displayed. As described above, it is necessary to distinguish the center image from the other images among the plurality of images. Accordingly, here, such an image is defined as a main image.

The type 407 of the image shown in FIG. 4C has a main image flag, a low-order image flag, and a high-order image flag stored therein. In the main image flag, “1” is stored when the image is a main image and “0” is stored otherwise. In the low-order image flag, “1” is stored when the image is positioned at a level lower than the other images and “0” is stored otherwise. In the high-order image flag, “1” is stored when the image is positioned at a level higher than the other images and “0” is stored otherwise.

In the type information in the figures, information indicating the relationship among a plurality of images in the present multi-image format is stored. The information indicating the relationship among the images contains the type of the function and detailed information, and is represented by the combination of the type of the function and the detailed information.

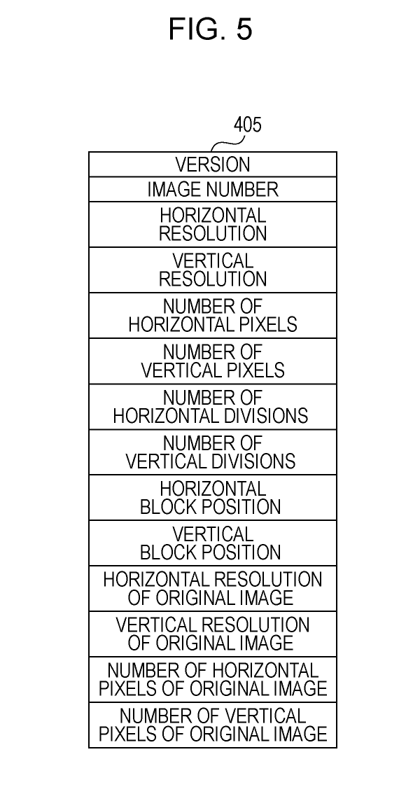

FIG. 5 is an illustration of an individual image information IFD in a multi-image format in the present embodiment. This corresponds to the individual image information IFD 405. In this individual image information IFD 405, as basic information, the version in a multi-image format and the image number assigned to each image are stored. Furthermore, as information on each image, the horizontal resolution, the vertical resolution, the number of horizontal pixels, the number of vertical pixels, the number of horizontal divisions, the number of vertical divisions, the horizontal block position, and the vertical block position are stored.

The above information will be described. As will be described later, in the present embodiment, a reduced image in which the original image is reduced and a plurality of divided images in which the original image is divided are generated as one file. Accordingly, as position information indicating the position in the original image of the divided images, the number of horizontal divisions, the number of vertical divisions, the horizontal block position, and the vertical block position are stored.

Furthermore, as the information on the original image, the horizontal resolution of the original image, the vertical resolution of the original image, the number of horizontal pixels of the original image, and the number of vertical pixels of the original image are stored.

Here, position information is attached, as the attached information of the image, to each image. However, the information may be collectively stored in an index area, such as the index IFD 404 or the header of the file, for making references to information regarding a plurality of images. In that case, for example, the position information of the image is stored in the type 407 of the image within the entry corresponding to each image.

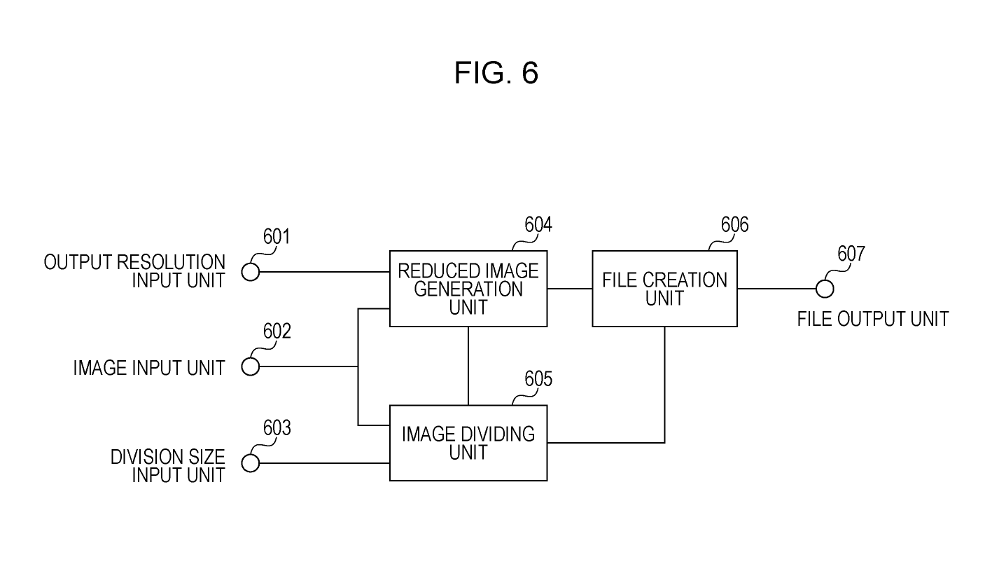

FIG. 6 shows a software structure that creates a multi-image format file in the first embodiment. As a result of this software being executed by the CPU 200, a file can be created. In FIG. 6, reference numeral 601 denotes an output resolution input unit for inputting the output resolution information of the reduced image that is output in the reduced image generation unit 604 (to be described later). Reference numeral 602 denotes an image input unit for inputting an original image as input image information. Reference numeral 603 denotes a division size input unit for inputting the division size information of divided images that are output in an image dividing unit 605 (to be described later).

Reference numeral 604 denotes a reduced image generation unit that reduces the input image information input by the image input unit 602 in accordance with the output resolution information input by the output resolution input unit 601. This output resolution information indicates the resolution of the image to be used when the entire image that is not divided is to be displayed, and the reduced image generation unit 604 reduces the image so that this resolution is reached. Usually, the resolution is a resolution smaller than the resolution of the original image. For this reason, in the reduced image generation unit 604, usually, an image reduction process is performed. Furthermore, in a case where the output resolution is greater than or equal to the resolution of the input image information, a variable-magnification process of the reduced image generation unit 604 may not be performed. Reference numeral 605 denotes an image dividing unit that divides input image information in accordance with the division size and that generates a plurality of divided images. Here, the image division size is usually a size smaller than the image size of the input image information. In a case where the division size is greater than or equal to the image size of the input image information, the image dividing unit 605 may not perform image division. Reference numeral 606 denotes a file creation unit that creates a file having the above-mentioned structure of a multi-image format on the basis of a reduced image output from the reduced image generation unit 604 and a divided image output from the image dividing unit 605. Reference numeral 607 denotes a file output unit that outputs a file created by the file creation unit.

A description will be given more specifically with reference to FIG. 6. For example, it is considered that a memory card having an image stored therein is loaded into the card interface of the MFP 100, and the image input unit 602 receives a stored image. Also, in response to an operation by the user on a ten-key pad of the operation unit 101, or the like, an image may be input into the output resolution input unit 601 and the division size input unit 603, so that the user specifies the output resolution and the division size.

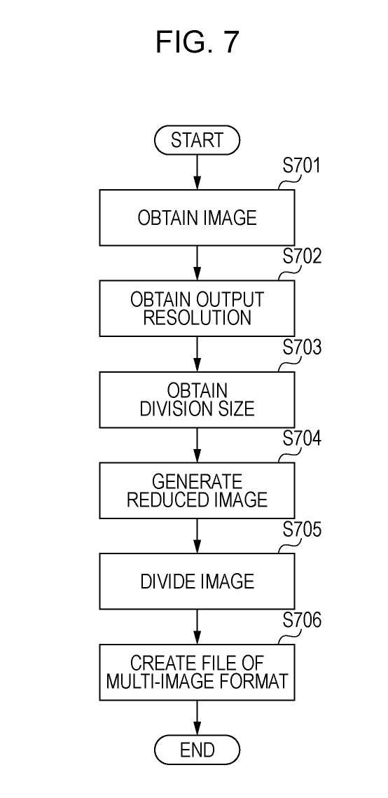

FIG. 7 shows a flow in which processing is performed on the basis of the software structure shown in FIG. 6 so as to generate an output image. When the processing is started, in step S701, the image information on the original image is obtained by the image input unit 602. In a case where the obtained image information has been compressed or encrypted, a decompression or decoding process should be performed in step S701. Furthermore, in step S702, the output resolution is obtained by the output resolution input unit 601. In step S703, the image division size is obtained by the division size input unit 603. Next, in step S704, a reduced image is generated by the reduced image generation unit 604 on the basis of the information obtained in steps S701 and S702. In a case where the output resolution obtained in step S702 is greater than or equal to the resolution possessed in advance by the image information obtained in step S701, a reduction process is not performed in step S704, and the input image information is output as is. Next, in step S705, the image dividing unit 605 generates divided images that are divided without variably magnifying the input image on the basis of the information obtained in steps S701 and S703. When the division size obtained in step S703 is larger than the image size possessed in advance by the image information obtained in step S701, in step S705, a process for dividing an image is not performed, and the input image information is output as is. Then, in step S706, the file creation unit 606 creates the above-mentioned file of a multi-image format on the basis of the reduced image generated in step S704 and the divided image generated in step S705. The file size of each of the reduced image and the divided images can be reduced by using a compression method used in JPEG or the like in which discrete cosine transform and Huffman encoding are combined, or another compression method. The compression process can be performed in step S706 at the time of file generation. However, when adapting to a device such as an embedded device, in which the amount of memory is limited, it is preferable that the amount of data to be temporarily stored inside the device be reduced. For this purpose, it is recommended that, by performing a compression process in step S704 or S705, in which the reduced image and the divided images are generated, the amount of data to be temporarily stored is reduced. Furthermore, in a case where processing is not performed in the above-mentioned manner in both S704 and S705 and the input image is output as is, the file may be created by using only one of the output images. In that case, a file may be created in a format that handles a known single image of JPEG or the like rather than the above-mentioned file of a multi-image format. Furthermore, the image information obtained in step S701 may be output as is without using the output result in step S704 or S705.

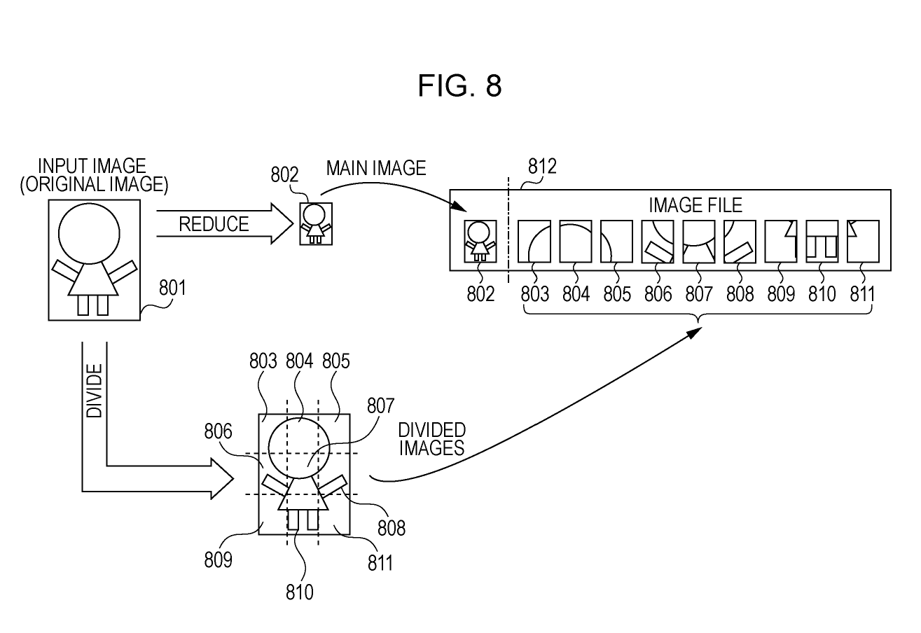

FIG. 8 illustrates generation of a file of a multi-image format according to the first embodiment. In FIG. 8, reference numeral 801 denotes an input image input in step S701. Reference numeral 802 denotes a reduced image generated on the basis of the input image 801 in step S704. Reference numerals 803 to 811 each denote a divided image generated from the input image 801 in step S705. Reference numeral 812 denotes an image file of a multi-image format generated in step S706.

The reduced image 802 is used when it is desired to roughly refer to the entire image. For example, in a case where a plurality of different objects exist, the entire image is displayed on the display unit or the like when the user selects a desired image. Furthermore, the divided images are used when, for example, a portion of the original image is to be enlarged and displayed by accessing the data in divided units.

Here, as described above, in the image file of a multi-image format, the input image is set as a main image, making it possible to distinguish it from the other images. Accordingly, the following file generation is considered. The main image flag of the type 407 of the image in the entry corresponding to the reduced image 802 shown in FIG. 4 is set to 1, and the reduced image 802 is set as the main image of the image file 812. Additionally, the main image flags of the divided images 803 to 811, which are the other images, are set to 0. Then, since the reduced image 802 is the main image of the image file 812, the use frequency thereof is considered to increase to more than that of the other images. For this reason, for the reduced image 802, the first image shown in FIG. 3A is recommended to be stored as the first image of the image file 812. When the image file 812 is to be created, the individual image information IFD shown in FIG. 5 is attached to each of the reduced image 802 and the divided images 803 to 811.

As described above, it is possible to distinguish the reduced image 802 and the divided images 803 to 811 on the basis of the main image flag. However, in a case where a detailed display rather than the entire display is desired to be a basic display, there is a case in which the main image flag should be set to an image different from that of the above-described case. For example, a method is considered in which the left upper image of the divided image or the image corresponding to the basic display position of the divided images is set to a main image. However, in the above-described method, if the main image flag is switched, the types of the reduced image 802 and the divided images 803 to 811 are also switched in synchronization with each other. For this reason, the detailed information in the type information shown in FIG. 4C may be set to a value differing from the main image flag, so that the reduced image 802 and the divided images 803 to 811 are distinguished from each other.

In a case where the reduced image 802 is used as a main image, the reduced image 802 is used for the user to select a desired image when, for example, a plurality of different objects exist. Therefore, it is preferable that the reduced image 802 can be displayed at a high speed. For this reason, it is preferable that the resolution of the reduced image 802 be minimized as much as possible. In the example of FIG. 8, although the divided images 803 to 811 are divided into nine portions, the present invention is not limited to this. For example, the divided image is intended to reduce needless data access when a part area is to be expanded and displayed by accessing data in divided units. For this reason, the number of divisions should be determined so that the number of pixels of each divided image is smaller than or equal to a predetermined number of pixels. On the other hand, when the number of divisions is very large, the number of times the selection process (to be described later) is performed when the image to be used is to be identified from among the divided images increases, and the process speed is decreased, causing the time necessary for displaying the image to be increased. For this reason, an upper limit may be provided for the number of divisions, or a predetermined fixed value may be used. Furthermore, up to the resolution at which the original image is generated, applications in which an expansion display is performed are considered to be possible. For this reason, the number of pixels or the number of divisions of the divided images may be determined on the basis of the number of pixels of the original image.

In particular, in a case where a device in which the image file of the present invention is mainly used is presumed, the resolution of the reduced image 802 or the number of divisions of the divided images 803 to 811 may be determined in accordance with the performance possessed by the apparatus. For example, as a result of making the size of the reduced image or the divided images to be a size that easily fall within the RAM of the apparatus, it is possible to reduce the number of times of access to an external storage device whose access speed is slow, with the result that a high-speed display is made possible. Furthermore, by determining the size of the reduced image or the divided image on the basis of the resolution of the display unit of the apparatus or the printing resolution of the printing unit, it is possible to efficiently perform an output process, such as variable magnification, which is performed at the time of output.

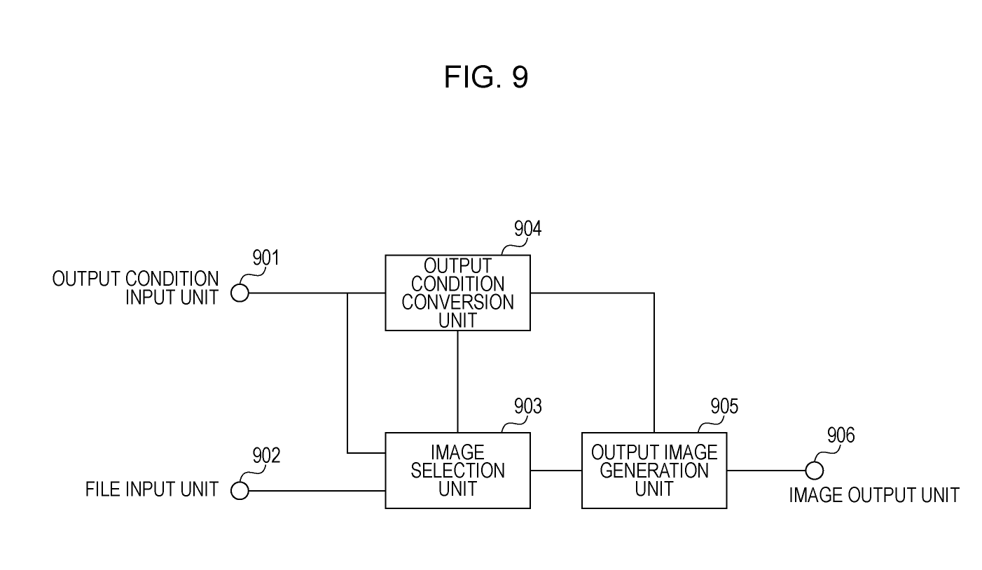

Next, the output of a multi-image format file in the present embodiment will be described. FIG. 9 shows the software structure that outputs a multi-image format file in the first embodiment. As a result of this software being executed by the CPU 200, an output image can be generated. In FIG. 9, reference numeral 901 denotes an output condition input unit that inputs output conditions of an image. The output conditions are information, such as the output area, the magnification ratio, and the number of output pixels, which are necessary when an image is to be output. Reference numeral 902 denotes a file input unit that inputs the image file 812 of a multi-image format. Reference numeral 903 denotes an image selection unit that selects an image to be used for image output from the image file 812 on the basis of the output conditions that are input by the output condition input unit 901. Reference numeral 904 denotes an output condition conversion unit that converts the output conditions on the basis of the output conditions and the information on the selected image selected by the image selection unit 903. Reference numeral 905 denotes an output image generator that generates an output image on the basis of the selected image selected by the image selection unit 903 and the output conditions converted by the output condition conversion unit 904. Reference numeral 906 denotes an image output unit that outputs an output image generated by the output image generator 905.

As described with reference to FIG. 8, the reduced image may be used as a main image for the user to select an image file. For example, it is assumed that a memory card in which a plurality of image files of a multi-image format in the present embodiment are stored is loaded into the card interface of the MFP 100. In that case, the reduced image is displayed on the display unit 204 so that the user is made to perform an operation on the operation unit 101. Then, inputs to the output condition input unit 901 and the file input unit 902 in FIG. 9 may be determined on the basis of the operation by the user.

First, the reduced image, which is a main image of each image file, is displayed on the display unit 204. Then, when the user operates the operation unit 101 so as to select an image file, an image file selected in response to the operation is determined. In that case, the file input unit 902 obtains an image file determined to have been selected by the user on the basis of the input from the operation unit 101.

Furthermore, the reduced image of the image file determined to have been selected by the user may be displayed on the display unit 204 so that the user operates the operation unit 101 so as to select a part area of the reduced image. In that case, on the basis of the input from the operation unit 101, the output condition input unit 901 obtains information indicating the area selected by the user.

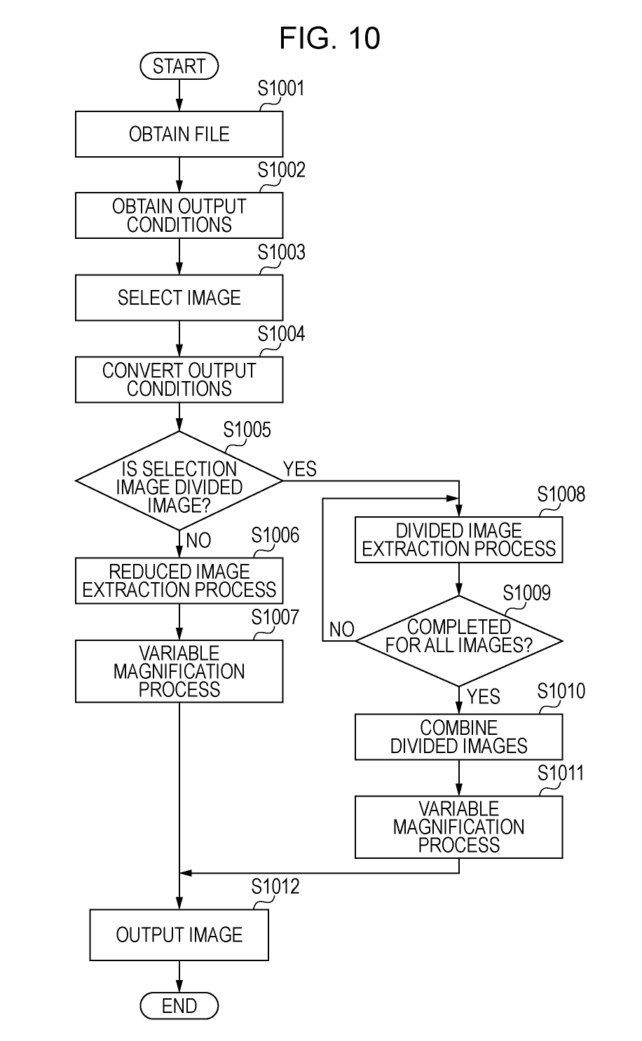

Next, a process for generating an output image from the above-described image file of a multi-image format will be described. FIG. 10 shows a flow in which processing is performed on the basis of the software structure shown in FIG. 9 and an output image is generated. When the processing is started, in step S1001, the file input unit 902 obtains a file of a multi-image format. Then, in step S1002, the output condition input unit 901 obtains output conditions with respect to the original image, such as the output area, the magnification ratio, and the number of output pixels. Then, in step S1003, the image selection unit 903 selects one or more images having a specific resolution from among the images contained in the file of a multi-image format obtained in step S1001 by a method (to be described later) on the basis of the output conditions obtained in step S1002. The process of S1003 is performed by comparing the magnification ratio contained in the output conditions with the above-described information associated with each image described with reference to FIG. 5. For example, by comparing the output area contained in the output conditions with the position information indicating the position to which each image corresponds in the original image, an image contained in the output area is selected.

Next, in step S1004, the output conditions for the original image, which are obtained in step S1002, are converted into selected image output conditions appropriate for the resolution of the image selected in step S1003. In step S1005, it is determined whether or not the selected image is a divided image. When the image has not been divided, the process proceeds to S1006, and when the image has been divided, the process proceeds to S1008. In a case where the image selected in step S1005 has not been divided, in step S1006, a extraction process is performed for extracting, from the selected image, a range appropriate for the selected image output conditions obtained in step S1004. Then, in step S1007, a variable-magnification process is performed on the extracted image at a variable magnification ratio appropriate for the selected image output conditions obtained in step S1004. Then, in step S1012, an image is output.

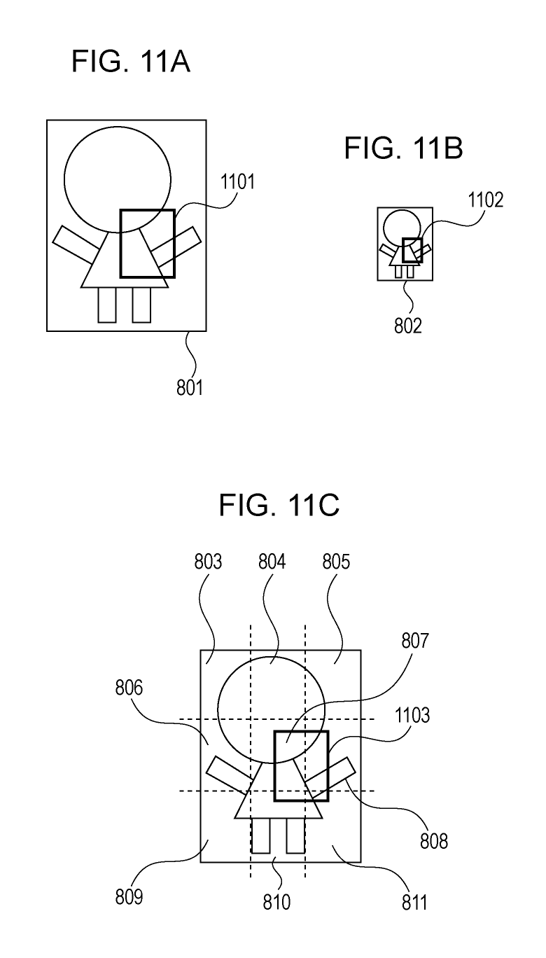

On the other hand, in a case where the selected image is a divided image, in step S1008, each of the selected divided images is compared with each of the selected image output conditions, and a extracted divided image is generated. This extracted divided image is an image in an area contained in the range indicated by the selected image output condition among the divided images. The details will be described later with reference to FIGS. 11A, 11B, and 11C. In step S1009, it is determined whether or not the extraction process of S1008 has been performed on all the selected images. If the processing on all the images has been completed, the process proceeds to S1010. Then, in step S1010, the extracted divided images are combined (concatenated). Thereafter, in step S1011, a variable-magnification process is performed on the combined images at a variable magnification ratio appropriate for the selected image output conditions obtained in step S1004. Then, in step S1012, the image is output.

The processing of S1006, S1008, and S1010 is performed by comparing the output area contained in the output conditions or the selected image output conditions with the information, such as the block position and the number of pixels, which is associated with each image described with reference to FIG. 5. Furthermore, in the process of S1007 or S1011, the processing is performed by comparing the magnification ratio and the number of output pixels contained in the output conditions with the information, such as the number of pixels of the combined images.

Furthermore, in the example shown in FIG. 5, the position information in the original image of each image and the information corresponding to the image, such as the number of pixels, are attached to each image. However, the information may be collectively stored in, for example, the index IFD 404. In that case, since information corresponding to a plurality of images can be collectively referred to, when comparing with the output conditions, it is not necessary to access an area corresponding to each of the plurality of images in the file. As a consequence, the processing in steps S1003, S1008, and S1010 becomes simple, and the processing can be performed at a higher speed.

In the above-described description, the variable-magnification process in step S1011 of FIG. 10 may be the same process as S1007. Furthermore, in a case where the variable-magnification process performed in step S1011 is a reduction process, since the combining process performed in step S1010 is performed on an image of a large size, the amount of processing in step S1010 increases. For this reason, in a case where the variable-magnification process is a reduction process, the order of S1010 and S1011 may be reversed so that after a reduction process is performed, the images are combined. Furthermore, in a case where the image extraction processes in steps S1006 and S1008 can be shared and the variable-magnification processes in steps S1007 and S1011 can be shared, the branching of S1005 is not performed, and the processing may be realized by only the processing of S1008 to S1011. In this case, in the process for combining divided images in step S101, the processing should not be performed on an image that has not been divided.

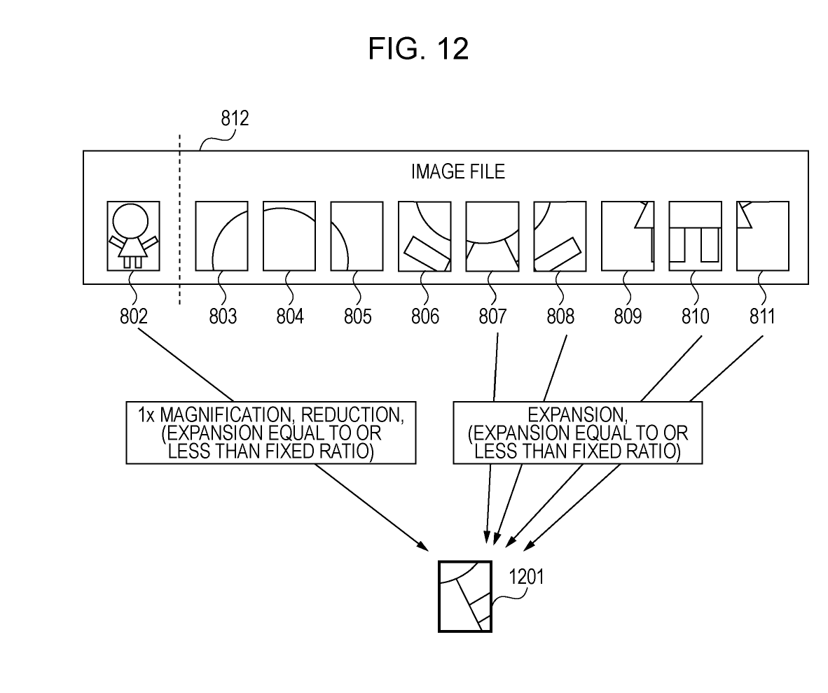

Next, the selection and extraction of an image, which is described with reference to FIG. 10, will be described with reference to FIGS. 11A, 11B, and 11C, and FIG. 12. FIGS. 11A to 11C show extraction of an image when an image file of a multi-image format in the first embodiment is to be output. Reference numeral 1101 of FIG. 11A denotes output area information for the input image 801 as the original image and is information contained in the output conditions obtained in step S1002. Then, reference numeral 1102 of FIG. 11B denotes selected image output area information for the reduced image 802. The selected image output area information 1102 is determined on the basis of the output area information 1101 and the reduction ratio of the reduced image 802 in step S1004. Additionally, reference numeral 1103 of FIG. 11C denotes selected image output area information for a divided image. In the present embodiment, since the divided image is set at the same resolution as that of the original image, reference numeral 1103 denotes the same data as reference numeral 1101. The selection of the image in step S1003 is performed in accordance with the output magnification ratio and the resolution of the images 802 to 811 contained in the image file 812. Then, as shown in FIG. 12, in a case where the output magnification ratio is smaller than or equal to the reduction ratio of the reduced image 802, the reduced image 802 is selected, and otherwise, the divided images 803 to 811 are selected. Even when the output magnification ratio is greater than the reduction ratio of the reduced image 802, if the output magnification ratio is an output magnification ratio equal to or less than a fixed value, the reduced image 802 may be adopted. Here, in a case where the divided images 803 to 811 have been selected, furthermore, in step S1008, the output area information is compared with the block position information of each of the divided images 803 to 811 so as to select a divided image in which the output area information is contained. FIG. 11C shows a state of image selection when a divided image is selected. Images 807, 808, 810, and 811 contain output area information 1103. FIG. 12 shows the selection of an image when an image file of a multi-image format in the first embodiment is to be output. Then, as shown in FIG. 12, an output image 1201 is generated by using the divided images 807, 808, 810, and 811.

Here, a typical usage of outputting a multi-image format file in the present embodiment will be described. First, the user selects a file to be used on a display device and then sets a position at which the image is desired to be expanded, causing an expansion display of a specific area to be performed. In this case, when the user selects a file, the image displayed first should be generated from the reduced image 802 indicating the overview. Alternatively, as described above, an image whose main image flag is set at 1 may be displayed. In this case, one of the divided images will be selected. It can be assumed that the resolution of the image whose main image flag is set at 1 has the most important meaning. Then, an image for an initial display may be generated from all the images having the same resolution as that of the image whose main image flag is 1. Furthermore, the divided images whose main image flag is 1 can be made to have the most important meaning in the entire area. In this case, an image for an initial display may be generated from only the divided images whose main image flag is 1 or from the divided image whose main image flag is 1 and divided images in the surroundings thereof. Then, after the initial display, when the user changes the display area, the output conditions are determined. In this case, the output conditions determined first become the output conditions for the display image at the time of change setting. For this reason, when the output conditions are to be input in step S1002, the output conditions should be temporarily converted to the output conditions for the original image, and should be converted once more to the output conditions for the image that has been selected in step S1004. Furthermore, the output conditions may not be temporarily converted into the output conditions for the original image, and in step S1004, the output conditions may be changed directly from the output conditions for the display image at the time of change setting to the output conditions for the image that has been performed selected in step S1003.

The image file of a multi-image format as has been described above is not limited to that described in the present embodiment. For example, the type of information contained in the individual image information IFD of a multi-image format of FIG. 5 may be, in addition to that described in FIG. 5, another value calculated from that described in FIG. 5. Furthermore, in the present embodiment, an example has been described in which the reduced image 802 is used at 1× magnification, at a reduction, or at an expansion equal to or less than a fixed magnification ratio, and the divided images 803 to 811 are used in the other cases. However, for example, in a case where the resolution of the display on which the image is displayed is higher than the resolution of the reduced image 802, if the display image generated from the reduced image 802 is used, the display quality is decreased. Therefore, in a case where the image is selected also in consideration with the resolution of the display and the resolution of the display is higher, a high-quality entire display image may be generated by using the divided images 803 to 811. Alternatively, first, for the purpose of a display at high speed, a low-quality entire display image is generated by using the reduced image 802. Then, a high-quality entire display image is generated by using the divided images 803 to 811, and at the time when the high-quality entire display image is generated, a switching to a high-quality entire display image may be made.

Furthermore, in a case where an image is to be output in the embodiment, an image file to be output may be output and displayed on the display unit 204 or may be output to the printing unit 104, whereby printing is performed on a printing sheet.

As has been described above, according to the present embodiment, an image file is created using an image in which the original image is reduced and a plurality of divided images in which the original image is divided. Therefore, when an image is to be output, one of the reduced image and the divided images needs to be output in accordance with the resolution at the output. Furthermore, when a divided image is to be output, only the necessary divided image needs to be read. Therefore, even a high-resolution image can be accessed at a high speed. Furthermore, according to the present embodiment, since images having a plurality of different resolutions are contained in one image file, it is possible for the user to easily handle a case in which the image is stored on an external storage medium.

### Second Embodiment

In the above-described first embodiment, a reduced image and a plurality of images formed from divided images at 1× magnification are generated from the input original image, and a file of a multi-image format is created from the generated images. In the present embodiment, an example is shown in which, furthermore, by generating divided images at a plurality of different resolutions, more efficient output of images is realized. Components which are the same as those of the first embodiment are designated with the same reference numerals, and descriptions thereof are omitted.

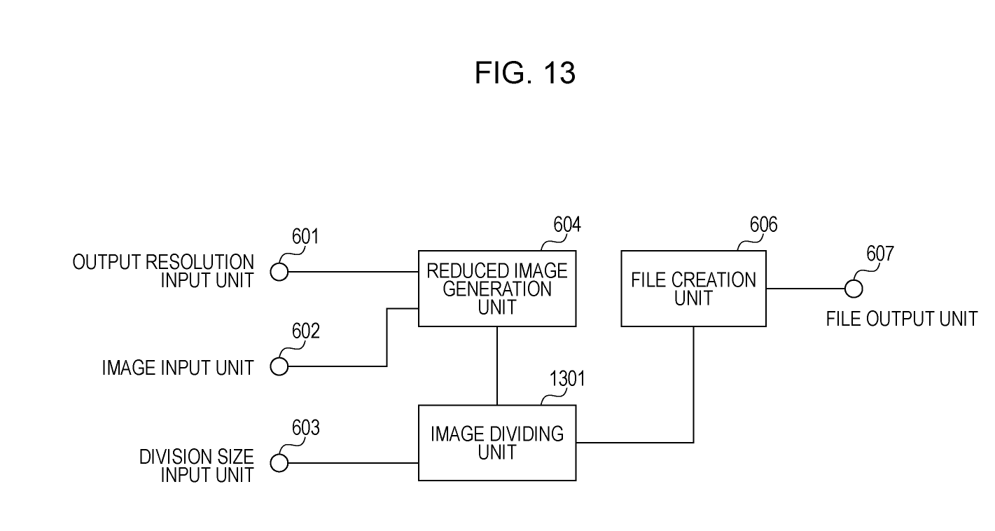

FIG. 13 shows a software structure that creates a multi-image format file in the second embodiment. In the present embodiment, regarding division of an image, a division process is performed on not only an image of the same resolution as that of the input image, but also on an image in which a reduction process has been performed. For this purpose, the output resolution input unit 601 and the division size input unit 603 receive information on a plurality of images, and the reduced image generation unit 604 outputs a plurality of reduced images. Then, an image dividing unit 1301 generates divided images on the basis of inputs from the image input unit 602 and the reduced image generation unit 604. In a case where divided images are to be generated from a 1× magnification image rather than from a reduced image, the reduced image generation unit 604 performs a variable-magnification process at 1× magnification or outputs the input image information as is without performing a variable-magnification process. Furthermore, in a case where division of an image is not performed, the image information received by the image dividing unit 1301 is output as is.

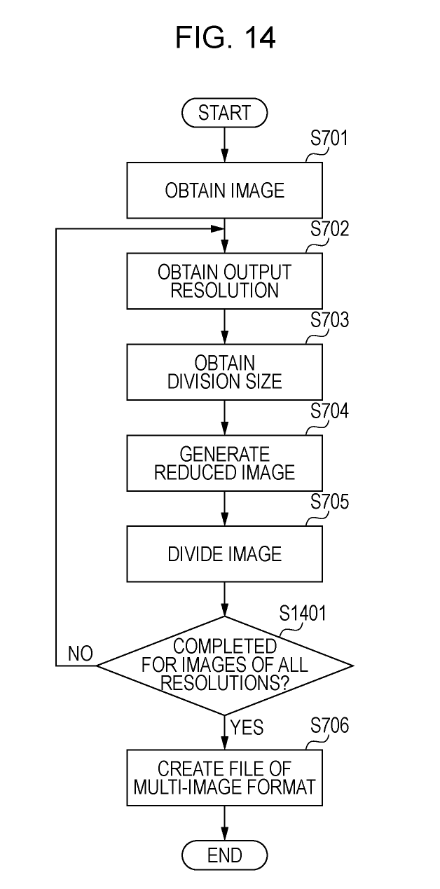

FIG. 14 shows a flow in which processing is performed on the basis of the software structure shown in FIG. 13 so as to create a multi-image format file. The processing from S701 to S705 is the same as that of FIG. 7 showing the operation flow of the first embodiment, and accordingly, the description is omitted. When the divided images for the image of one resolution are generated in step S705, in step S1401, a determination is made as to whether or not the processing for the images of all the resolutions has been completed. If the processing for the images of all the resolutions has not been completed, the process returns to S702, where the next output resolution information is obtained. In a case where the amount of memory is small as in an embedded device, there is a case in which all the image information obtained in step S701 cannot be stored. In this case, the process may not return to S702 from S1401, but may return to S701. Then, when it is determined in step S1401 that the processing for the images of all the resolutions has been completed, in step S706, a file of a multi-image format is created.

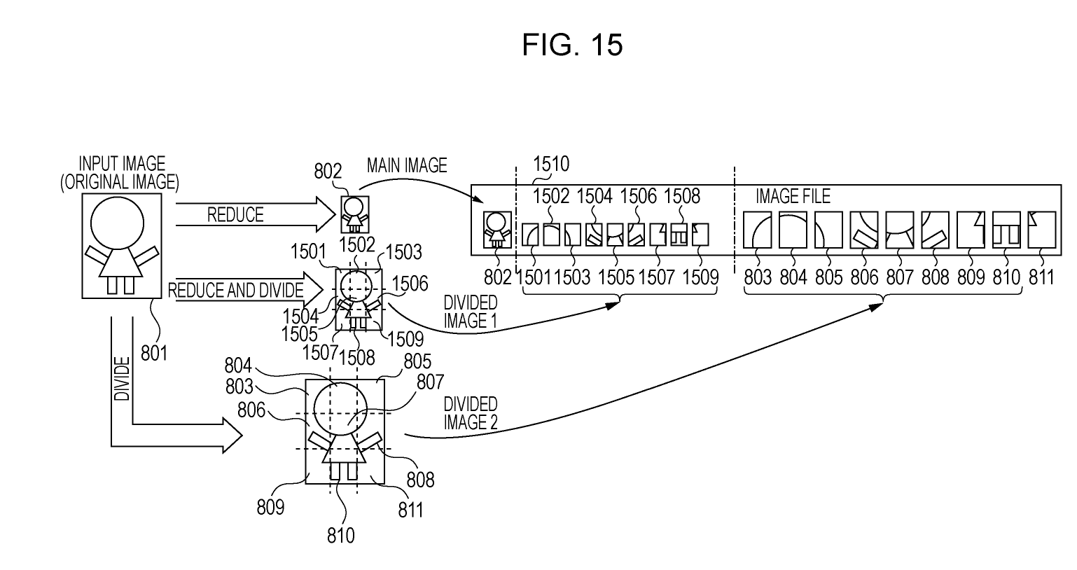

FIG. 15 illustrates generation of a file of a multi-image format in the second embodiment. Referring to FIG. 15, an example will be described in which, in addition to one reduced image that is not divided (reduced non-divided image) and a plurality of divided images at 1× magnification (1× magnification divided images), a file of a multi-image format having a plurality of reduced divided images is contained. Similarly to that described with reference to FIG. 8, the reduced image 802 of the figure is an image in which the original image is reduced and is not divided. The divided images 803 to 811 are images in which the original image is not reduced and is divided. Reference numerals 1501 to 1509 denote images in which an image on which a reduction process has been performed so as to have a resolution higher than that of the reduced image 802 is further divided. That is, in a case where the reduced image 802 has been generated by reducing the original image at a first reduction ratio, the images 1501 to 1509 are generated by dividing an image that is reduced at a second reduction ratio smaller than the first reduction ratio. The reduced image 802 may be referred to as a first reduced image, and an image before being divided into the images 1501 to 1509 may be referred to as a second reduced image. Then, an image file 1510 of a multi-image format is made to contain the reduced image 802, the reduced divided images 1501 to 1509, and the divided images 803 to 811.

Depending on the configuration of the device to be used, in the case in which data to be used is consecutively stored in the storage device, it is possible to access the data at a higher speed than a case in which data is stored in a distributed manner. Additionally, in a case where an image is to be output, if the resolution of the image used is determined in step S1003, the images of the other resolutions are not used. For this reason, the reduced image 802, the reduced divided images 1501 to 1509, and the divided images 803 to 811 should be consecutively stored in the file for each resolution.

Next, a description will be given of a process for generating an output image from an image file of a multi-image format in the present embodiment. The software structure and the processing flow of portions that generate an output image in the present embodiment are the same as in FIGS. 9 and 10 showing the configuration of the first embodiment, respectively. The difference from the first embodiment is that objects to be selected of the image selection unit 903 (step S1003 in FIG. 10) in FIG. 9 contain the reduced divided images 1501 to 1509. In this case, when a resolution image is to be selected in step S1003, a resolution image having a magnification ratio that is closest to the output resolution from among the plurality of resolution images should be selected. Furthermore, in step S1003, an image may be selected so that an expansion process will not occur in an image other than a resolution image at the highest resolution in step S1011. That is, an image having a resolution higher than the resolution to be output may be selected so that a reduction process is performed in step S1011. As a result, by performing an expansion process, it is possible to prevent details from being lost at a specific magnification ratio of the output image.

Selection of an image from divided images in the first embodiment has been described with reference to FIG. 11C. In the present embodiment, the divided images 803 to 811 shown in FIG. 11C are considered by being substituted with the reduced divided images 1501 to 1509. In this case, the selected image output area information indicated by 1103, similarly to the selected image output area information 1102 of FIG. 11B, has been converted from the output area information 1101 for the original image into information in which the reduction ratio of the reduced divided images 1501 to 1509 is considered.

In the present embodiment, an example has been described which contains a file of a multi-image format having, in addition to one reduced non-divided image and 1× magnification divided images, reduced divided images in which an image is reduced at one reduction ratio. However, the present invention is not limited to this. For example, the file may have reduced divided images that have been reduced at a plurality of different reduction ratios. Alternatively, one of a reduced non-divided image and a non-reduced 1× magnification image, or both of them need not be contained. Furthermore, a plurality of reduced images that have not been divided may exist at different resolutions. Furthermore, although the number of divisions of the reduced divided images 1501 to 1509 is the same as that of the divided images 803 to 811, the number of divisions may be changed for each resolution.

### Third Embodiment

In the above-described first and second embodiments, a description has been given of a method in which one high-resolution image is input, and images having a plurality of resolutions and divided images are generated so as to create a file of a multi-image format. In the present embodiment, more specifically, a description will be given of a case in which a high-resolution image is input from the reading unit 103. For example, in a case where a document is to be read using the reading unit 103, when the entire document is read at a high resolution, one large image is obtained. However, in a case where the capacity of the RAM 202 is insufficient, the above-described processing cannot be performed, or the image needs to be temporarily stored in an external storage device with a slow access speed.

Therefore, in the present embodiment, a method will be described in which one high-resolution image is not input, but a reading operation is performed in a divided manner when a document is to be read, thereby creating a file of a multi-image format in which the size of a RAM to be used is reduced. It is assumed in the present embodiment that an external storage medium, such as a memory card, has been loaded into the card interface 102 in the MFP 100 or is connected to an external storage medium, such as a hard disk, which is connected to a server or the like through a communication unit (not shown). Then, it is assumed that the file of a multi-image format is created on the external storage medium.

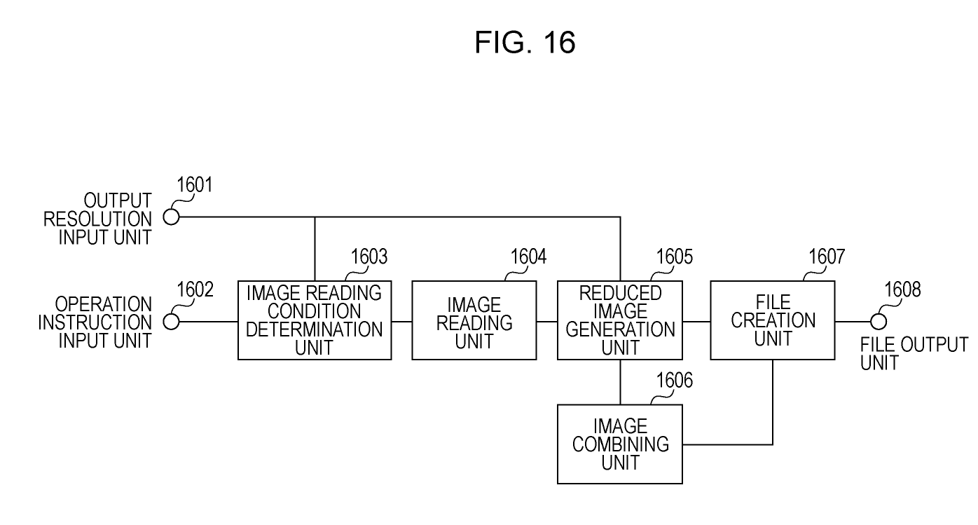

FIG. 16 shows a software structure that creates a multi-image format file in the third embodiment. Reference numeral 1601 denotes an output resolution input unit that inputs the output resolution of an image stored in a file. As described in the second embodiment, the file of a multi-image format in the present invention contains images of a plurality of different resolutions. For this reason, information on a plurality of resolutions is input to the output resolution input unit 1601. Next, reference numeral 1602 denotes an operation instruction input unit that accepts an instruction of starting a scanner operation. Not only a mere signal of starting operation, but also operation conditions of the size of a document, the reading range, and the like are input from the operation instruction input unit 1602. Reference numeral 1603 denotes an image reading condition determination unit that determines reading conditions of the scanner on the basis of the output resolution input by the output resolution input unit 1601. In the image reading condition determination unit 1603, the highest resolution among the resolutions input from the output resolution input unit 1601 is adopted as the resolution of the reading conditions. Then, on the basis of the operation conditions input by the operation instruction input unit 1602 and the output resolution information, reading conditions including the reading resolution and the reading range are determined.

In the present embodiment, the reading operation by the scanner is performed for a plurality of divided areas. For this purpose, the image reading condition determination unit 1603 outputs a plurality of reading conditions of different reading ranges. Reference numeral 1604 denotes an image reading unit that causes a scanner to operate so as to read a document on the basis of the reading conditions. Reference numeral 1605 denotes a reduced image generation unit that performs a reduction process on an image read from the image reading unit 1604 on the basis of the output resolution so as to generate reduced images. Reference numeral 1606 denotes an image combining unit that combines the reduced images generated by the reduced image generation unit 1605 so as to generate one combined image. Reference numeral 1607 denotes a file creation unit that creates a file of a multi-image format from the reduced images and the combined image. Reference numeral 1608 denotes a file output unit that outputs a file of a multi-image format.

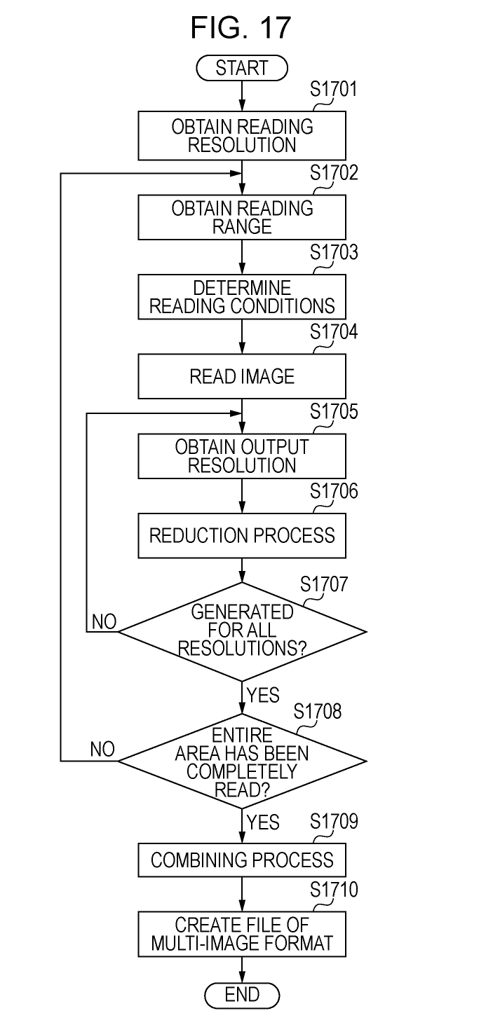

FIG. 17 shows a flow in which processing is performed on the basis of the software structure shown in FIG. 16 so as to generate a multi-image format file. When the processing is started, initially, in step S1701, a reading resolution is obtained. This reading resolution, as described above, is the highest resolution among the resolutions input from the output resolution input unit 1601. Next, in step S1702, the reading range is obtained. For the reading range, a plurality of areas are set with respect to one document. Then, in step S1703, the reading conditions are determined on the basis of the reading resolution obtained in step S1701 and the reading range obtained in step S1702. In step S1704, a high-resolution part image is read by the reading operation of the scanner. In step S1705, resolution information on a plurality of resolution images to be generated is obtained. In step S1706, reduced part images are generated. In step S1707, it is determined whether or not all the resolution images to be output have been generated. If the generation has not been completed, the process returns to S1705, where a process for generating a reduced part image is repeated. On the other hand, when it is determined in step S1707 that all the resolution images have been generated, it is determined in step S1708 whether or not the reading operation of S1704 has been completed for the entire area of the document. When it is determined in step S1708 that the reading operation has not yet been completed, the process returns to S1702, where an operation of reading a document is performed. On the other hand, when it is determined in step S1708 that the reading operation for the entire area has been completed, in step S1709, a process for combining part images with a lowest resolution is performed to generate a low-resolution entire image. Then, when a necessary image is generated, in step S1710, the above-mentioned file of a multi-image format is generated.

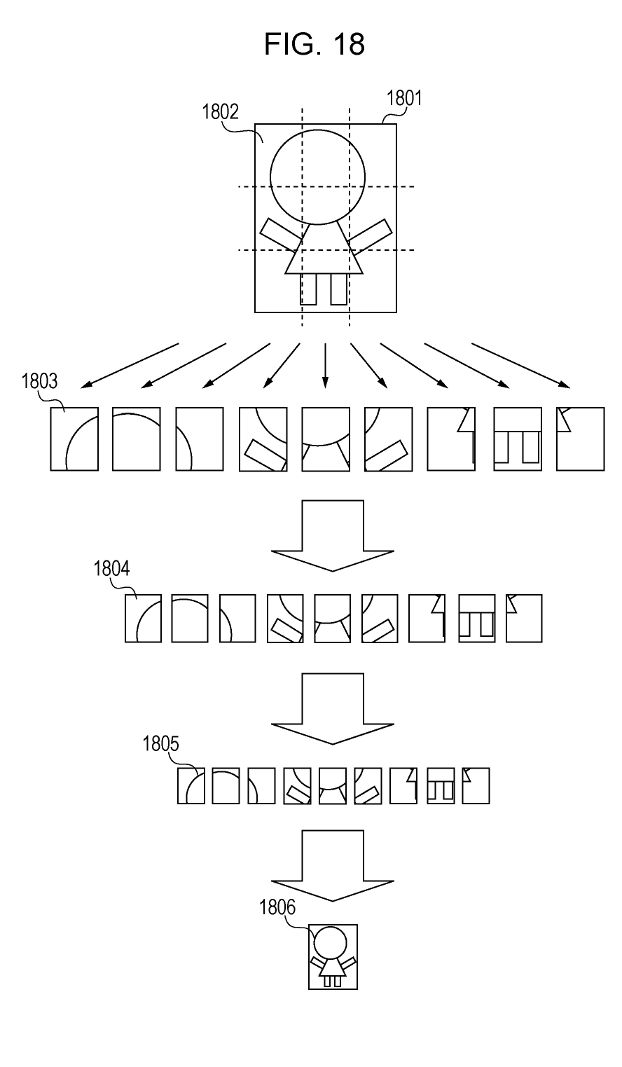

FIG. 18 illustrates generation of a file of a multi-image format in the third embodiment. Referring to FIG. 18, reference numeral 1801 denotes a document on a scanner document holder. Reference numeral 1802 denotes a left upper divided area in which the reading range of the document 1801 is divided. The reading in step S1704 is performed for each area in which the document 1801 is divided. Reference numeral 1803 denotes a high-resolution divided image obtained by reading the area 1802. When the reading of the part image 1803 by the scanner is completed, the reduction process of S1706 is performed, and a part image 1804 of a low resolution is generated from the part image 1803. Furthermore, in a case where a low-resolution part image is to be generated, a part image 1805 is generated from the part image 1804. The above description has been given on an image corresponding to the left upper area 1802, and the same processing is performed on the other part areas.

Then, when part images having the same resolution as that of the part image 1805 having the lowest resolution image are generated for the entire area, a combining process shown in step S1709 is performed on the part image of the lowest resolution, thereby generating a low-resolution entire image 1806.

Here, the part image 1805 may be generated from the part image 1803, which is a higher resolution image, rather than being generated from the part image 1804. The above-described examples show that three resolution images are generated, but the present invention is not limited to this. Furthermore, in the above-described examples, the entire image is generated regarding a lowest resolution image. However, the entire image may be generated regarding another resolution, and a plurality of entire images may be generated at different resolutions.

Furthermore, when a file of a multi-image format is to be generated, the file may be created after all the necessary images are generated. However, in a case where the capacity of the RAM of the device is small, there is a case in which the image needs to be temporarily stored on an external storage medium with a slow access speed. Therefore, storage control of sequentially storing images that are no longer used in the reduction process in step S1706 or in the combining process in step S1709 in the external storage device should be performed, so that the images are sequentially output to the file. For example, output should be performed in the procedure in which immediately after the part image 1804 is generated, the image 1803 is stored in the file.

Furthermore, the total size of a document in the present embodiment is recommended to be specified by using a user interface installed in the scanner device. Alternatively, the entire surface of the document holder may be read beforehand at a low resolution in order to automatically detect the size of the document, and image processing may be performed on the obtained low-resolution image, thereby specifying the size of the document. Then, the division size may be determined in accordance with the detected size of the document. Furthermore, the obtained low-resolution image may be stored so that it is used in place of the low-resolution entire image 1806.

In the above-described first to third embodiments, a description has been given by assuming that processing is performed in the MFP 100, but the present invention is not limited to this. For example, the processing described in the first and second embodiments may be performed by a PC (Personal Computer). In this case, the high-resolution image which is the original image in the case of an MFP may be input from an external storage medium, such as a memory card in the manner described above or may be input from a hard disk possessed by the device. Furthermore, an image may be externally input via a network. In the case of the third embodiment, a high-resolution image may be input from a connected scanner device. In the case of the MFP, it is assumed that an instruction from the user is input through an operation on the operation unit. In the case of a PC, an instruction from the user may be input from an external operation device, such as a mouse or a keyboard. Furthermore, in a case where an image is to be output, it may be output to an external printing device and printed, may be output to an external display device and displayed, or may be output to a communication unit provided in the PC and transmitted via a network. Furthermore, in the present invention, processing may be performed by a portable information terminal, such as a mobile phone, in addition to a PC. For example, in a case where the processing of the third embodiment is performed by a portable information terminal, such a terminal is effective since the memory capacity thereof is smaller than the PC.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-323643, filed Dec. 19, 2008, which is hereby incorporated by reference herein in its entirety.

What is claimed is:

1. An image processing apparatus for creating an image file, comprising:
an input unit configured to input an image;
a generation unit configured to generate a reduced image by reducing the input image and configured to generate a plurality of divided images by dividing the input image; and
a creation unit configured to create an image file containing the reduced image and the plurality of divided images and containing, in one index area, a plurality of items of position information indicating a position to which each of the plurality of divided images corresponds in the input image.

2. The image processing apparatus according to claim 1, wherein the generation unit reduces the input image at a first reduction ratio so as to generate a first reduced image and at a second reduction ratio, lower than the first reduction ratio, so as to generate a second reduced image, and wherein the generation unit divides the second reduced image so as to generate a plurality of divided images.

3. The image processing apparatus according to claim 1, wherein resolution information indicating the resolution of the input image is input, and the generation unit reduces the input image at a reduction ratio in accordance with the resolution information.

4. The image processing apparatus according to claim 1, wherein size information indicating a size into which the input image is divided is input, and the generation unit divides the input image into the size in accordance with the size information.

5. The image processing apparatus according to claim 1, wherein the creation unit creates the image file in which position information corresponding to the plurality of divided images is attached to a predetermined image contained in the plurality of divided images.

6. An image processing apparatus that outputs an image, comprising:
an obtaining unit configured to obtain an image file containing a reduced image in which an image is reduced and a plurality of divided images in which the image is divided and containing, in one index area, position information indicating a position to which each of the plurality of divided images corresponds in the image;
an input unit configured to input area information indicating an output area to be output within the image; and
an output unit configured to select, on the basis of the position information, at least one divided image corresponding to the output area indicated by the area information among the plurality of divided images contained in the image file and configured to output the image contained in the output area among the selected at least one divided image.

7. The image processing apparatus according to claim 6, wherein the output unit extracts and outputs the image contained in the output area among the selected at least one divided image.

8. The image processing apparatus according to claim 7,
wherein the output unit selects, on the basis of the position information, a plurality of divided images corresponding to the output area indicated by the area information among the plurality of divided images contained in the image file,
wherein the output unit extracts a plurality of images contained in the output area among the selected plurality of divided images, and
wherein the output unit combines the plurality of extracted images on the basis of the position information and outputs the combined image.

9. The image processing apparatus according to claim 7, wherein the output unit extracts and outputs the image corresponding to the output area from the reduced image on the basis of a result in which a resolution at which output is performed is compared with a resolution of a plurality of images contained in the image file.

10. The image processing apparatus according to claim 6, wherein the output unit outputs and displays the image on a display device.

11. The image processing apparatus according to claim 6, wherein the output unit outputs the image to a printing device, whereby the image is printed.

12. An image processing method for creating an image file, comprising:
inputting an image;
generating a reduced image by reducing the input image and generating a plurality of divided images by dividing the input image; and
creating an image file containing the reduced image and the plurality of divided images and containing, in one index area, position information indicating a position to which each of the plurality of divided images corresponds in the input image.

13. An image processing method for outputting an image, comprising:
obtaining an image file containing a reduced image in which an image is reduced and a plurality of divided images in which the image is divided and containing, in one index area, position information indicating a position to which each of the plurality of divided images corresponds in the image;
inputting area information indicating an output area to be output within the image;
selecting, on the basis of the position information, at least one divided image corresponding to the output area indicated by the area information among the plurality of divided images contained in the image file; and
outputting the image contained in the output area among the selected at least one divided image.

14. A computer-readable storage medium having stored thereon a program for causing a computer to execute the image processing method according to claim 12.

15. A computer-readable storage medium having stored thereon a program for causing a computer to execute the image processing method according to claim 13.
